(19) United States
(12) Patent Application Publication
(10) Pub. No.: US 2014/0329409 A1
(43) Pub. Date: Nov. 6, 2014

(54) ELECTRONIC DEVICE AND SOCKET CONNECTOR USED IN ELECTRONIC DEVICE

(71) Applicant: Nvidia Corporation, Santa Clara, CA (US)

(72) Inventors: Bo Su, Santa Clara, CA (US); Zhi Li, Santa Clara, CA (US); Qiang Chen, Santa Clara, CA (US)

(21) Appl. No.: 13/937,958

(22) Filed: Jul. 9, 2013

(30) Foreign Application Priority Data
May 2, 2013 (CN) 201310157509.2

(51) Int. Cl. H01R 24/22

(52) U.S. Cl. CPC H01R 24/22
USPC 439/607.18; 439/660

(57) ABSTRACT

An electronic device and a socket connector used in the electronic device are presented. The socket connector comprises a housing and a flexible sheet-shaped conductor. The housing comprises a housing body. The flexible sheet-shaped conductor is fixed on the housing body and electrically connected to the housing body, wherein at least a portion of the flexible sheet-shaped conductor protrudes forward from a front end of the housing body so that the flexible sheet-shaped conductor is electrically connected to a casing of an electronic device when the socket connector is mounted in the electronic device.

### CROSS-REFERENCE TO RELATED APPLICATIONS

This application claims priority to Chinese Patent Application No. 201310157509.2, filed on May 2, 2013, which is hereby incorporated by reference in its entirety.

### TECHNICAL FIELD

The present disclosure generally relates to electronic devices, and more particularly to an electronic device and a socket connector used in the electronic device.

### BACKGROUND

The socket connector, such as an HDMI (High Definition Multimedia Interface) connector and a DP (Display Port) connector etc., is a kind of widely used electronic element disposed in the electronic devices such as computers, televisions, Ethernet transceivers and so on so that the conductor (wire) is connected with appropriate matched elements to realize the signal transmission between different electronic devices. The connecting part of the housing of the socket connector is disposed in the housing body or protrudes outward from the casing of the electronic device to be connected with the external plug. In order to shield the external interference signals, the housing of the socket connector and the casing are both grounded. However, if the housing of the socket connector is not in good electrical contact with the casing, it may result in larger electric resistance between them. In such circumstance, the grounding effect will be influenced, and in turn the shielding to the signal line in the socket connector is influenced so that the signal transmission is apt to be interfered and the transmission quality may also be influenced.

Nowadays, in order to solve the electrical contact problem between the housing of the socket connector and the casing, in some socket connectors a curved metal spring is designed on the housing body of the housing. When the socket connector is mounted to the electronic device, the housing of the socket connector is electrically connected to the casing of the electronic device through the metal spring, and then is grounded through the casing of the electronic device.

However, the method mentioned above causes that the structure of the socket connector is complex, the mounting of the socket connector is inconvenient and the cost is relatively high. Since only two sides of the curved metal spring are utilized to be connected with the casing of the electronic device, the contacting area is small and the effect of the electromagnetic shielding is weak.

### SUMMARY

A socket connector used in the electronic device is disclosed according to one aspect of the present disclosure. The socket connector comprises a housing comprising a housing body. The socket connector also comprises a flexible sheet-shaped conductor fixed on the housing body and electrically connected to the housing body. At least a portion of the flexible sheet-shaped conductor protrudes forward from a front end of the housing body so that the flexible sheet-shaped conductor is electrically connected to a casing of the electronic device when the socket connector is mounted in the electronic device.

An electronic device is further disclosed according to another aspect of the present disclosure. The electronic device comprises a casing provided with a socket connector opening. The electronic device also comprises a socket connector with a portion of a front end thereof exposed through the socket connector opening. The socket connector comprises a housing which comprises a housing body. The socket connector also comprises a flexible sheet-shaped conductor fixed on the housing body and electrically connected to the housing body. At least a portion of the flexible sheet-shaped conductor protrudes forward from a front end of the housing body to abut against the casing and be electrically connected to the casing of the electronic device.

### BRIEF DESCRIPTION

In order that the advantages of the disclosure will be readily understood, a more detailed description of the disclosure briefly described above will be rendered by reference to specific embodiments that are illustrated in the appended drawings. Understanding that these drawings depict only typical embodiments of the disclosure and are not therefore to be considered to be limiting of its scope, the disclosure will be described and explained with additional specificity and detail through the use of the accompanying drawings.

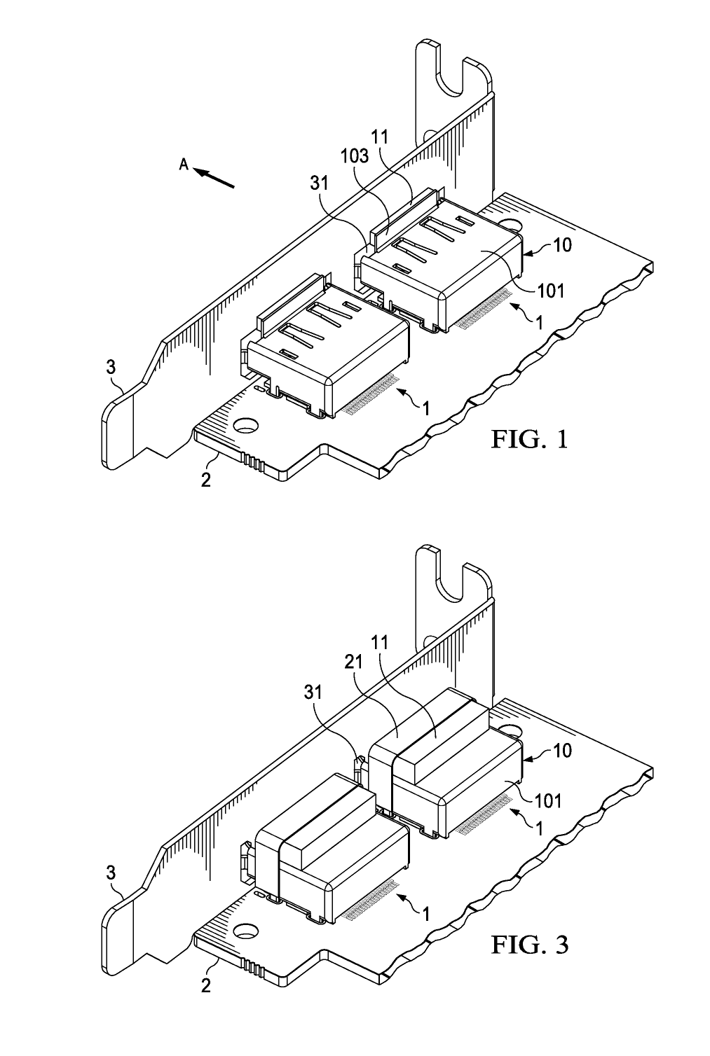

FIG. 1 is a side perspective schematic view of a socket connector in accordance with a first embodiment of the present disclosure when the socket connector is mounted in an electronic device ;

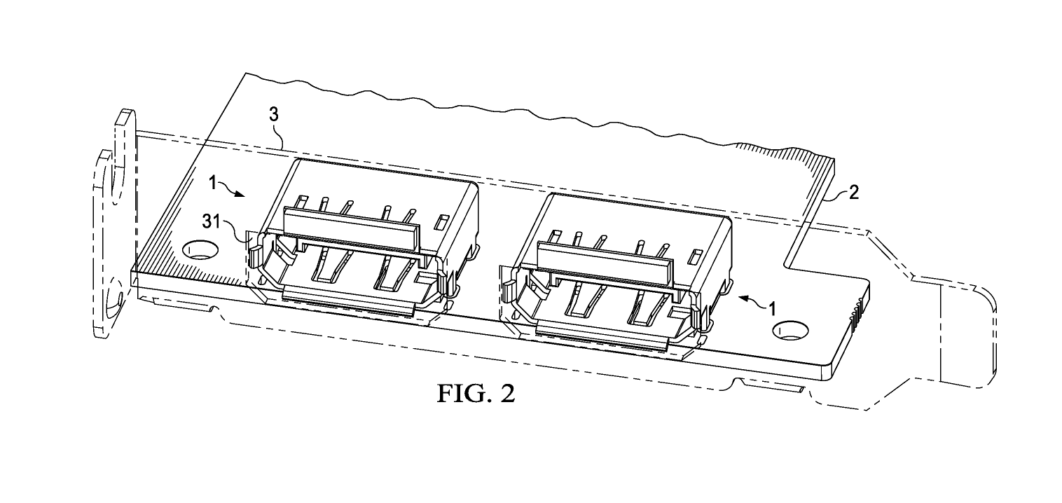

FIG. 2 is a front perspective schematic view of the socket connector shown in FIG. 1 when the socket connector is mounted in the electronic device;

FIG. 3 is a side perspective schematic view of a socket connector in accordance with a second embodiment of the present disclosure when the socket connector is mounted in an electronic device ; and

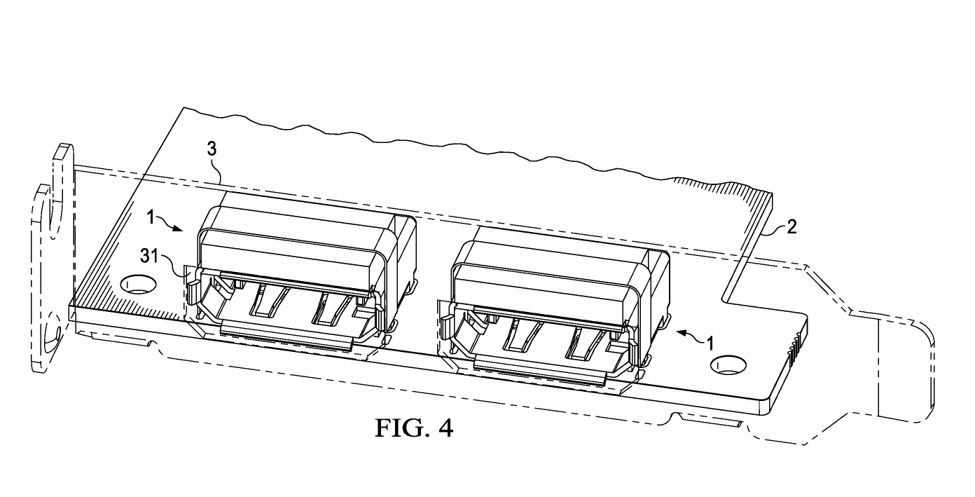

FIG. 4 is a front perspective schematic view of the socket connector shown in FIG. 3 when the socket connector is mounted in the electronic device.

### DETAILED DESCRIPTION

In the following discussion, details are presented so as to provide a more thorough understanding of the present disclosure. However, the present disclosure may be implemented without one or more of these details as would be apparent to one of ordinary skill in the art. Certain examples are illustrated without elaborate discussion of technical features that would be within the purview of one of ordinary skill in the art so as to avoid confusion with the present disclosure.

A socket connector used in an electronic device is provided according to one aspect of the present disclosure. A side perspective schematic view and a front perspective schematic view of the socket connector according to a first embodiment of the present disclosure when the socket connector is mounted in the electronic device are shown in FIG. 1 and FIG. respectively. For clarity, only a PCB 2 and a portion of a casing 3 in the electronic device are shown in FIG. 1 and FIG. 2. The socket connector 1 in the present embodiment is an HDMI connector. Of course, in practice the socket connector 1 may also be any other type of socket connectors such as a DP connector, among others. In addition, the socket connector in the present embodiment is used in a computer, however the socket connector according to the present disclosure may also be the socket connector used in other electronic devices such as televisions, Ethernet transceivers, etc.

As shown in FIG. 1 and FIG. 2, the socket connector 1 according to the first embodiment of the present disclosure comprises a housing 10. In the present embodiment, when the socket connector 1 is mounted in the electronic device, the housing 10 is fixed on the PCB in the electronic device, and a portion of a front end of the socket connector 1 is exposed through a socket connector opening 31 on the casing 3 of the electronic device for being connected with a plug outside the electronic device to realize signal transmission. The housing 10 comprises a housing body 101 and a connecting part (not shown) for being connected with the plug outside the electronic device. The connecting part is located in the housing body 101 in the present embodiment. While in other embodiments which are not shown, such as a DP connector, the connecting part may protrude forward from a front end of the housing body 101. The housing body 101 is made of a conductive material such as metal material and the signal transmission portion disposed in the interior of the housing body 101 is connected to the wiring on the PCB 2.

As shown in FIG. 1 and FIG. 2, the socket connector further comprises a flexible sheet-shaped conductor 11 fixed on the housing body 101 and electrically connected therewith. Moreover the flexible sheet-shaped conductor 11 protrudes forward from the front end of the housing body 101 so that the flexible sheet-shaped conductor 11 can abut against the casing 3 of the electronic device and be electrically connected to the casing 3 of the electronic device when the socket connector 1 is mounted in the electronic device.

In the socket connector 1 of the present embodiment, at least a portion of the flexible sheet-shaped conductor 11 fixed on the housing body 101 of the housing 10 protrudes forward from the front end of the housing body 101 so that the forward protruded portion of the flexible sheet-shaped conductor 11 can be ensured to be electrically connected to the casing 3 of the electronic device in front of the housing body 101 through simply adjusting the position relation between the socket connector 1 and the casing 3 of the electronic device when the socket connector is mounted in the electronic device. On the other hand, the flexible sheet-shaped connector 11 itself may be fixed on the housing body 101 and is electrically connected to the housing body 101 so that the housing 10 of the socket connector 1 is electrically connected to the casing 3 of the electronic device by means of the flexible sheet-shaped conductor 11. Meanwhile, by means of the flexibility of the conductor 11, through merely arranging the relative position between the socket connector 1 and the casing 3 of the electronic device, it can be achieved that the flexible sheet-shaped conductor 11 abuts against the casing 3 of the electronic device closely and fixedly, and consequently the housing 10 of the socket connector 1 and the electronic device become reliably electrically connected.

Furthermore, compared with the scheme that the electrical connection between the socket connector and the casing is realized by utilizing a metal spring, the conductor 11 in the present embodiment is sheet-shaped so that the contact between the conductor 11 and the housing body 101 of the socket connector 1 and the contact between the conductor 11 and the casing 3 of the electronic device are both surface contact, and consequently the electrical connection between the housing 10 of the socket connector 1 and the casing 3 of the electronic device is enhanced and the grounding effect becomes better. Therefore, this structure of the socket connector 1 can shield the external interference signals more effectively.

It should be noted that the terms “front” and “forward” herein are intended to refer to the direction indicated by the arrow A in FIG. 1, i.e. the direction pointing outward from the electronic device and being perpendicular to the surface of the casing 3 of the electronic device in which surface the socket connector 1 is exposed when the socket connector 1 is mounted in the electronic device. In addition, the flexible sheet-shaped conductor 11 in the present embodiment is entirely located at the front end of the housing body 101, and consequently the whole flexible sheet-shaped conductor 11 protrudes forward from the front end of the housing body 101. However, in other embodiments according to the present disclosure, at least a portion of the flexible sheet-shaped conductor 11 protrudes forward from the front end of the housing body 101 to make the electrical connection to the casing of the electronic device.

The flexible sheet-shaped conductor 11 may be a sheet-shaped structure made of any flexible conductive material such as metal material. In one embodiment, the flexible sheet-shaped conductor 11 may comprise an EMI Gasket or be completely made of an EMI Gasket. The EMI Gasket has good surface conductivity and elasticity, and consequently helps to realize better electrical connection between the housing body 101 of the socket connector and the casing 3 of the electronic device. Furthermore, the EMI Gasket is apt to be cut into suitable shapes and dimensions according to the specific structures of the electronic device and the socket connector 1, and is apt to be glued to be affixed to and fixed on the housing body 101 so as to be mounted conveniently.

The manners that the flexible sheet-shaped conductor is fixed on the housing body 101 may be various. In one embodiment, the flexible sheet-shaped conductor 11 may be fixed on the housing body 101 by a conductive adhesive. The operation of this fixing manner is simple and convenient without the need of any additional fixing element such as screws. This manner is particularly appropriate for the situation that the flexible sheet-shaped conductor 11 and the housing body 101 are both miniaturization.

The flexible sheet-shaped conductor 11 may be fixed at various positions on the housing body 10 and the orientation of the flexible sheet-shaped conductor 11 relative to the housing body 10 may also be various. In one embodiment, as shown in FIG. 1, the housing body 10 in the present embodiment further comprises a fixing part 103 for fixing the flexible sheet-shaped conductor 11. The fixing part 103 is fixedly connected at the front end of the housing body 101 to a fixing surface of the housing body 101 and extends away from the fixing surface. The flexible sheet-shaped conductor 11 covers the front surface of the fixing part 103 and is fixed thereto to realize protruding forward from the front end of the housing body 101. When the socket connector 1 is mounted in the electronic device, the front surface of the flexible sheet-shaped conductor 11 abuts against the casing 3.

The term “fixing surface” herein is intended to refer to at least one of an upper surface, a lower surface and side surfaces of the housing body 101. Those skilled in the art may choose the position of the fixing part reasonably based on actual situation. In the present embodiment, as shown in FIG. 1, the fixing part 103 is fixedly connected at the front end of the housing body 101 to the upper surface of the housing body 101 and extends upward from the upper surface. Since the width of the front end of the upper surface of the socket connector 1 is relatively large, the fixing part 103 may be relatively large when the fixing part 103 is fixedly connected to the upper surface, and consequently, the area of the conductor 11 fixed thereto may also be relatively large so that the electrical conductivity between the socket connector 1 and the casing 3 of the electronic device may further be increased. Of course, according to actual situation and requirement, in other embodiments according to the present disclosure, the fixing part 103 may further comprise a portion fixedly connected at the front end of the housing body 101 to the lower surface of the housing body 101 and extends downward from the lower surface, a portion fixedly connected at the front end of the housing body 101 to the left side surface of the housing body 101 and extends leftward from the left side surface and a portion fixedly connected at the front end of the housing body 101 to the right side surface of the housing body 101 and extends rightward from the right side surface.

In the present embodiment, the flexible sheet-shaped conductor 11 covers a front surface of the fixing part 103 and is fixed thereto, while the fixing part 103 is located at the front end of the housing body 101, as a result, the flexible sheet-shaped conductor 11 protrudes forward from the front end of the housing body 101 completely. When the socket connector 1 is mounted in the electronic device, the flexible sheet-shaped conductor 11 is sandwiched between the socket connector 1 and the casing 3. By merely adjusting the relative position of the socket connector 1 and the casing 3, it can be ensured that the fixing part 103 and the casing 3 of the electronic device squeeze the flexible sheet-shaped conductor 11 from two sides, and consequently the contact between any adjacent two of them becomes closer. As a result, the electrical conductivity is increased and the grounding effect of the housing body through the casing of the electronic device is further increased.

The fixing part 103 may be any one of the various suitable shapes and be fixed to the housing body 101 through fixing elements such as screws and so on. In the present embodiment, the fixing part 103 is plate-shaped and is formed integrally with the housing body 101. For example, the fixing part 103 is formed by casting or by bending the protruded forward front end of the respective surface of the housing body 101. The plate-shaped fixing part 103 is apt to be manufactured and the cost of the socket connector 1 is reduced. Furthermore, the fixing part 103 being formed integrally with the housing body 101 may avoid creating gaps at the joint between the fixing part 103 and the housing body 101 so that the shielding effect of the socket connector is further increased.

In the present embodiment, the fixing part 103 extends perpendicularly to the fixing surface of the housing body 101 and consequently the fixing part 103 is parallel with the casing 3, which facilitates the conductor 11 being sandwiched therebetween. However, in other embodiments not shown in the drawings according to the present disclosure, the fixing part 103 is plate-shaped and integrally formed with the housing body 101, with the front surface being a single plane and an angle ranged from 45° to 135° being formed between the front surface and the fixing surface. The existence of this angle may cause the flexible sheet-shaped conductor 11 to generate deformation, and consequently to contact with the fixing part 103 more closely. When the angle is in the range of 90°-135° and the socket connector 1 is mounted in the electronic device, the fixing part 103 generates slightly backward deformation because of the pressure from the casing 3 by arranging the relative position between the socket connector 1 and the casing 3. And consequently, this deformation may result that the fixing part 103 applies an elastic force, which is inverse of the force applied by the casing 3 of the electronic device, to the flexible sheet-shaped conductor 11, and consequently the flexible sheet-shaped conductor 11 is squeezed more heavily so that the contact between any adjacent two of them becomes closer. As a result, the electrical conductivity is increased, and the grounding effect of the housing body through the casing of the electronic device is further increased. Of course, in other preferred embodiments, the front surface of the fixing part may also comprise a plurality of planes adjoining each other and extending in different directions (e.g., the front surface is winding), wherein an angle ranged from 45° to 135° is formed between each of the plurality of planes and the fixing plane. As a result, the fixing part of this structure may also make the contact between any adjacent two of the casing, the flexible sheet-shaped conductor and the fixing part closer and the electrical conductivity increased and the grounding effect of the housing body through the casing of the electronic device further increased.

A side schematic view and a front schematic view of a socket connector according to a second embodiment of the present disclosure when the socket connector is mounted in an electronic device are respectively shown in FIG. 3 and FIG. 4. For clarity, only a PCB 2 and a portion of a casing 3 are shown in FIG. 3 and FIG. 4. As shown in FIG. 3 and FIG. 4, the difference between the second embodiment and the first embodiment according to the present disclosure is that in the second embodiment, a flexible sheet-shaped conductor 11 covers one of an upper surface, a lower surface and two side surfaces of a housing body 101 and is fixed thereto, and a portion of the flexible sheet-shaped conductor 11 protrudes forward from the front end of the housing body 101. When the socket connector 1 is mounted in the electronic device, a front surface of the flexible sheet-shaped conductor 11 abuts against the casing 3. Those skilled in the art may choose the position of the flexible sheet-shaped conductor 11 reasonably according to actual situation. In the present embodiment, as shown in FIG. 3, the flexible sheet- shaped conductor 11 covers the upper surface of the housing body 101 and is fixed thereto. Since the area of the upper surface of the socket connector 1 is relatively large, the area of the conductor may be designed relatively large when the conductor 11 covers the upper surface and is fixed thereto, and consequently the electrical conductivity between the socket connector 1 and the casing 3 of the electronic device may be further increased. Of course, according to actual situation and requirement, in other embodiments according to the present disclosure, the flexible sheet-shaped conductor 11 may also cover one of the lower surface and side surfaces of the housing body 101 and be fixed thereto.

In the present embodiment, the flexible sheet-shaped conductor 11 covers the surface of the housing body 101 directly and is fixed thereto, and is electrically connected with the housing body 101, with a portion protruding forward from the housing body 101. Thus, when the socket connector 1 is mounted in the electronic device, it can be ensured that the flexible sheet-shaped conductor 11 abuts against the casing 3 of the electronic device and is electrically connected to the casing 3 by merely adjusting the relative position between the socket connector 1 and the casing 3. As a result, the electrical conductivity between the housing body 101 and the casing 3 of the electronic device is increased and then the grounding effect of the housing body 101 through the casing of the electronic device is increased. Meanwhile the fixing part provided in the first embodiment is not necessary any more and thus the manufacturing process of the socket connector 1 may be simplified and the cost may be saved. Furthermore, the applicant has discovered that compared with the situation that the conductor 11 wraps the upper surface, lower surface and the two side surfaces of the housing body 101, the shielding effect when the conductor 11 only covers one surface of the housing body 101 is substantially the same. Thus the material of the conductor 11 can be saved and the cost is reduced.

The surface area of the housing body covered by the flexible sheet-shaped conductor 11 may be chosen according to actual situation. In one embodiment, as shown in FIG. 3, the flexible sheet-shaped conductor 11 may cover more than ⅓ and less than ½ of the area of the surface on which it is located. The applicant has found that compared with covering the entire area of one surface of the housing body, the shielding effect is substantially the same and the material of the conductor 11 can be further saved to reduce cost when the covered area is in the above range

The flexible sheet-shaped conductor 11 may be fixed on the housing body 101 by a conductive adhesive, screws etc. In one embodiment, as shown in FIG. 3 and FIG. 4, in the present embodiment, the socket connector 1 further comprises an elastic annular clamp 21 which clamps the flexible sheet-shaped conductor 11 and the housing body 101 together to fix the flexible sheet-shaped conductor 11 on the housing body 101. When the flexible sheet-shaped conductor 11 is fixed on the housing body 101 through the conductive adhesive, the elastic annular clamp 21 may be further employed to clamp the flexible sheet-shaped conductor 11 and the housing body 101 together. Thus, the fixing stability of the flexible sheet-shaped conductor 11 on the housing body 101 can be further improved.

An electronic device is also provided according to another aspect of the present disclosure. As shown in FIGS. 1-4, the electronic device may comprise a casing 3 and any one of the socket connector 1 mentioned above. The casing 3 is provided with a socket connector opening 31. A portion of a front end of the socket connector 1 is exposed through the socket connector opening 31 for connecting with a plug outside the electronic device to realize signal transmission. The structure of the electronic device and the properties, characteristics and the connecting relations of relevant component contained in the electronic device may refer to the description of the respective part in above. Therefore, it is no longer described in details in the present disclosure for the sake of simplicity. The electrical conductivity between the socket connector and the casing of the electronic device is increased by the flexible sheet-shaped conductor, so that the grounding effect of the socket connector through the casing is further increased and the external interference signals can be shielded more effectively.

Accordingly, there is a need for providing an electronic device and a socket connector used in the electronic device to address the problem described above.

In some of the above-described embodiments, the housing body further comprises a fixing part fixedly connected at the front end of the housing body to a fixing surface of the housing body and extending away from the fixing surface, wherein the fixing surface is at least one of an upper surface, a lower surface and side surfaces of the housing body; the flexible sheet-shaped conductor covers a front surface of the fixing part and is fixed thereto.

In some of the above-described embodiments, the fixing part is plate-shaped and is formed integrally with the housing body.

In some of the above-described embodiments, the front surface of the fixing part is a single plane or comprises a plurality of planes adjoining each other and extending in different directions, wherein an angle of ranged from 45° to 135° is formed between the single plane or each of the plurality of planes and the fixing plane.

In some of the above-described embodiments, the fixing part extends upward from the upper surface of the housing body.

In some of the above-described embodiments, the fixing part extends perpendicularly to the fixing surface.

In some of the above-described embodiments, the flexible sheet-shaped conductor covers one of an upper surface, a lower surface and side surfaces of the housing body and is fixed thereto.

In some of the above-described embodiments, the flexible sheet-shaped conductor covers more than ⅓ and less than ½ of the area of the one of the upper surface, the lower surface and the side surfaces of the housing body.

In some of the above-described embodiments, the socket connector further comprises an elastic annular clamp which clamps the flexible sheet-shaped conductor and the housing body together.

In some of the above-described embodiments, the flexible sheet-shaped conductor is fixed on the housing body by a conductive adhesive.

In some of the above-described embodiments, the flexible sheet-shaped conductor comprises an EMI Gasket.

In the socket connector provided by the present disclosure, at least a portion of the flexible sheet-shaped conductor fixed on the housing body of the housing protrudes forward from the front end of the housing body so that the forward protruded portion of the flexible sheet-shaped conductor can be ensured to be electrically connected to the casing of the electronic device in front of the housing body through simply adjusting the position relation between the socket connector and the casing of the electronic device when the socket connector is mounted in the electronic device. On the other hand, the flexible sheet-shaped connector itself is fixed on the housing body and is electrically connected to the housing body so that the housing of the socket connector is electrically connected to the casing of the electronic device by means of the flexible sheet-shaped conductor. Meanwhile, by means of the flexibility of the conductor, through merely arranging the relative position between the socket connector and the casing of the electronic device, it can be achieved that the flexible sheet-shaped conductor abuts against the casing of the electronic device closely and fixedly, and consequently the housing of the socket connector and the electronic device become reliably electrically connected.

Furthermore, compared with the scheme that the electrical connection between the socket connector and the casing is realized by utilizing a metal spring, the conductor in the present embodiment is sheet-shaped so that the contact between the conductor and the housing body of the socket connector and the contact between the conductor and the casing of the electronic device are both surface contact, and consequently the electrical connection between the housing of the socket connector and the casing of the electronic device is enhanced and the grounding effect becomes better. Moreover, the sheet-shaped conductor is easily to be manufactured and mounted and the cost of the socket connector is reduced. Therefore, this structure of the socket connector can shield the external interference signals more effectively.

The foregoing description, for purpose of explanation, has been described with reference to specific embodiments. However, the illustrative discussions above are not intended to be exhaustive or to limit the disclosure to the precise forms disclosed. Many modifications and variations are possible in view of the above teachings. The embodiments were chosen and described in order to best explain the principles of the disclosure and its practical applications, to thereby enable others skilled in the art to best utilize the disclosure and various embodiments with various modifications as may be suited to the particular use contemplated.

Embodiments according to the disclosure are thus described. While the present disclosure has been described in particular embodiments, it should be appreciated that the disclosure should not be construed as limited by such embodiments, but rather construed according to the below claims.

What is claimed is:

1. A socket connector used in an electronic device, comprising:
a housing comprising a housing body; and
a flexible sheet-shaped conductor fixed on the housing body and electrically connected to the housing body, wherein at least a portion of the flexible sheet-shaped conductor protrudes forward from a front end of the housing body so that the flexible sheet-shaped conductor is configured to electrically connect to a casing of an electronic device when the socket connector is mounted in the electronic device.

2. The socket connector according to claim 1, wherein the housing body further comprises a fixing part fixedly connected at the front end of the housing body to a fixing surface of the housing body and extending away from the fixing surface, wherein the fixing surface is at least one of an upper surface, a lower surface and side surfaces of the housing body;
the flexible sheet-shaped conductor covers at least a portion of the front surface of the fixing part and is fixed thereto.

3. The socket connector according to claim 2, wherein the fixing part is plate-shaped and is formed integrally with the housing body.

4. The socket connector according to claim 3, wherein the front surface of the fixing part is a single plane or comprises a plurality of planes adjoining each other and extending in different directions, wherein an angle ranged from 45° to 135° is formed between the single plane or each of the plurality of planes and the fixing plane.

5. The socket connector according to claim 2, wherein the fixing part extends upward from the upper surface of the housing body.

6. The socket connector according to claim 2, wherein the fixing part extends perpendicularly to the fixing surface.

7. The socket connector according to claim 1, wherein the flexible sheet-shaped conductor covers at least a portion of one of an upper surface, a lower surface and side surfaces of the housing body and is fixed thereto.

8. The socket connector according to claim 7, wherein the flexible sheet-shaped conductor covers more than ⅓ and less than ½ of the area of the one of the upper surface, the lower surface and the side surfaces of the housing body.

9. The socket connector according to claim 7, wherein the socket connector further comprises an elastic annular clamp which clamps the flexible sheet-shaped conductor and the housing body together.

10. The socket connector according to claim 1, wherein the flexible sheet-shaped conductor is fixed on the housing body by a conductive adhesive.

11. The socket connector according to claim 1, wherein the flexible sheet-shaped conductor comprises an EMI Gasket.

12. An electronic device, comprising:
a casing provided with a socket connector opening; and
a socket connector with a portion of a front end thereof exposed by the socket connector opening, wherein the socket connector includes:
a housing which comprises a housing body; and
a flexible sheet-shaped conductor fixed on the housing body and electrically connected to the housing body, wherein at least a portion of the flexible sheet-shaped conductor protrudes forward from a front end of the housing body to abut against the casing and be electrically connected to the casing of the electronic device.

13. The electronic device according to claim 12, wherein the housing body further comprises a fixing part fixedly connected at the front end of the housing body to a fixing surface of the housing body and extending away from the fixing surface, wherein the fixing surface is at least one of an upper surface, a lower surface and side surfaces of the housing body;
the flexible sheet-shaped conductor covers a front surface of the fixing part and is fixed thereto, with a front surface of the flexible sheet-shaped conductor abutting against the casing.

14. The electronic device according to claim 13, wherein the fixing part is plate-shaped and is formed integrally with the housing body.

15. The electronic device according to claim 13, wherein the fixing part extends upward from the upper surface of the housing body.

16. The electronic device according to claim 13, wherein the fixing part extends perpendicularly to the fixing surface.

17. The electronic device according to claim 12, wherein the flexible sheet-shaped conductor covers at least a portion of one of an upper surface, a lower surface and side surfaces of the housing body and is fixed thereto, with a front end of the flexible sheet-shaped conductor abutting against the casing.

18. The electronic device according to claim 17, wherein the socket connector further comprises an elastic annular clamp which clamps the flexible sheet-shaped conductor and the housing body together.

19. The electronic device according to claim 12, wherein the flexible sheet-shaped conductor is fixed on the housing body by a conductive adhesive.

20. The electronic device according to claim 12, wherein the flexible sheet-shaped conductor comprises an EMI Gasket.
